(19) United States
(12) Patent Application Publication
(10) Pub. No.: US 2024/0403947 A1
(43) Pub. Date: Dec. 5, 2024

(54) EXTRACTING ITEM ATTRIBUTES FROM ITEM DESCRIPTIONS USING LARGE LANGUAGE MACHINE-LEARNED MODELS

(71) Applicant: Maplebear Inc., San Francisco, CA (US)

(72) Inventor: Shih-Ting Lin, Santa Clara, CA (US)

(21) Appl. No.: 18/677,588

(22) Filed: May 29, 2024

Related U.S. Application Data
(60) Provisional application No. 63/470,758, filed on Jun. 2, 2023.

(51) Int. Cl. G06Q 30/0601

(52) U.S. Cl. CPC G06Q 30/0643; G06Q 30/0627; G06Q 30/0631

(57) ABSTRACT

A system may obtain an item description associated with an item in an item catalog. The system may generate a prompt for input to a machine-learned language model, the prompt specifying at least the item description and a request to identify one or more attributes of the item. The system may provide the prompt to a model serving system for execution by the machine-learned language model. The system may receive from the machine-learned language model, an output including a list of attributes and respective values associated with the item based on the item description. The system may standardize the formatting of the list of attributes and may store the list of attributes and the respective values for the list of attributes in association with the item in the item catalog.

### CROSS-REFERENCE TO RELATED APPLICATIONS

This application claims the benefit of U.S. Provisional Application No. 63/470,758, filed Jun. 2, 2023, which is incorporated by reference herein in its entirety.

### BACKGROUND

An online system is an online platform that provides one or more online services. An example of an online service is allowing users to perform transactions associated with items. The items may represent physical entities stored in a physical location. A user can place an order for purchasing items from participating retailers via the online system, with the shopping being done by a picker. Descriptions of the items in an item catalog, often provided by the manufacturer or a vendor, are helpful for the customer to understand the corresponding products, but may be inaccessible to other system features. Because the item description is often unstructured text, data about the item in the description may be hard to integrate into other features in the online system. For example, any information in the item description cannot be used to filter the results of a search. The lack of structure of the information in the item description prevents that information from being useful for other features in the online catalog system.

### SUMMARY

In accordance with one or more embodiments of the disclosure, the techniques described herein relate to a method for a system extracting item attributes from item descriptions. The online system obtains an item description associated with an item in an item catalog and generates a prompt for input to a machine-learned language model, the prompt specifying at least the item description and a request to identify one or more attributes of the item. The online system provides the prompt to a model serving system for execution by the machine-learned language model and receives, from the machine-learned language model, an output including a list of attributes and respective values associated with the item based on the item description. The online system standardizes the formatting of the list of attributes for the item and stores the list of attributes and the respective values for the list of attributes in association with the item in the item catalog.

In some embodiments, the online system provides the item, the list of attributes and the respective values associated with the item to a user and receives, from the user, modifications to the list of attributes and the respective values associated with the item, and provides to the machine-learned language model the modifications, the list of attributes, and the respective values associated with the item for further training.

In some embodiments, the output from the machine-learned language model includes a list of relevant items, and the online system identifies a relevant item category for the item and the list of relevant items, as well as stores the relevant item category in association with each of the item and each item in the list of relevant items in the item catalog.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for extracting item attributes from item descriptions, in accordance with one or more embodiments.

FIGS. 4A-4B are exemplary user interfaces, in accordance with one or more embodiments.

FIG. 5 illustrates another exemplary user interface, in accordance with one or more embodiments.

### DETAILED DESCRIPTION

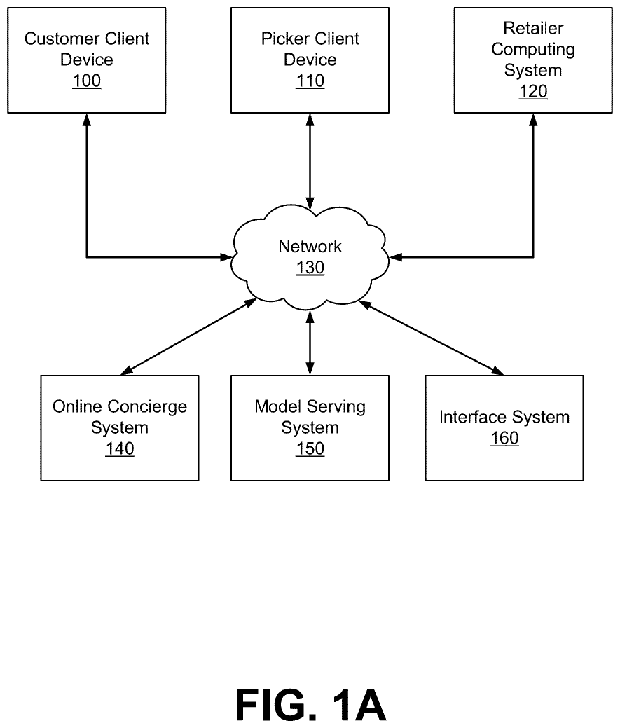

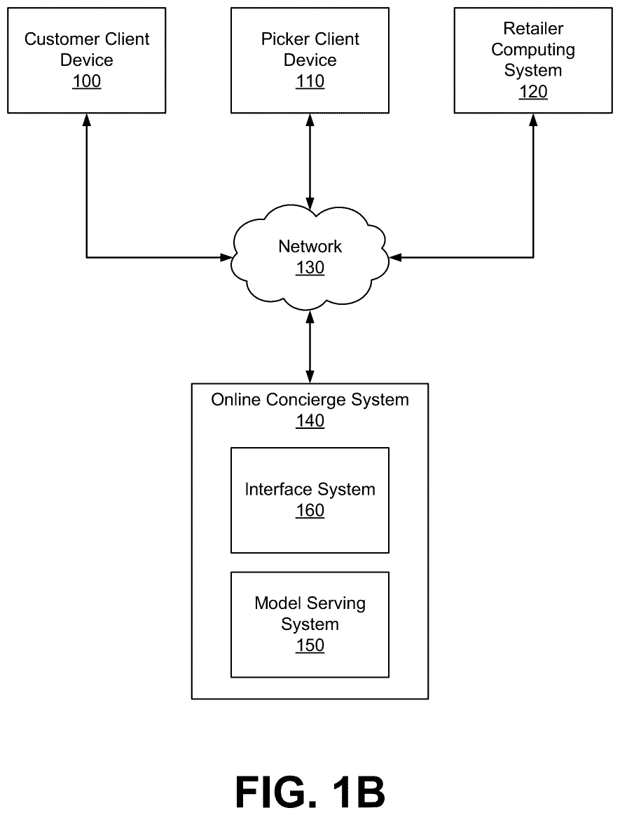

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item,” as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding, or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location.

For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

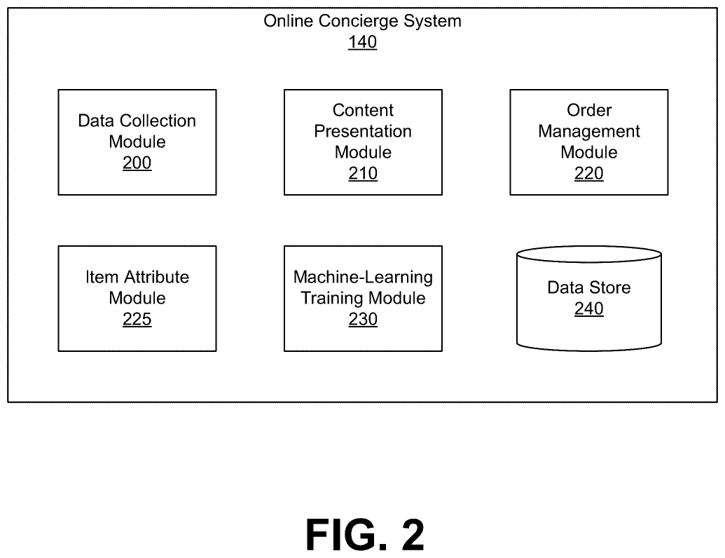

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

Conventionally, attribute extraction from unstructured data, such as item descriptions, can be done using rule-based or pattern-based techniques. For example, a conventional method may require identification of keywords or key phrases that indicate the presence of attributes within the item descriptions, such as, words like “size,” “color,” “brand,” “material,” etc. Search for these keywords or phrases within the item descriptions and extract the associated information. However, some item descriptions may not explicitly include such key words. For example, “strawberry” may be used to describe an item's flavor without the word “flavor” presented in the item description. These conventional methods require domain knowledge, expertise in text processing, and manual effort to define rules or patterns. While they can be effective in certain scenarios, they may not handle complex linguistic patterns or adapt well to diverse data sources.

By leveraging the machine-learned language model, the disclosure herein provides a method for extracting item attributes from unstructured data. The machine-learned language model is trained on large amount of input data with various modalities and is capable of understanding the context so that the model interprets the unstructured data and identifies the desired attributes and values of the items within the item descriptions. For example, the machine-learned language model may capture complex linguistic patterns and dependencies in text data, which is advantageous for attribute extraction tasks where attributes may be mentioned in various contexts and positions within the description. The machine-learned language model may understand the context of words within a sentence or paragraph, allowing them to make more accurate predictions about the attributes. The machine-learned language model also considers the surrounding words when generating predictions, which can improve accuracy. Additionally, the machine-learned language model may be finetuned and re-trained specifically for attribute extraction tasks and output customized attributes in a pre-defined format. The machine-learned language model may continuously learn and improve over time based on user feedback, customer review, usage history/pattern, etc. By leveraging these capabilities, the machine-learned language model effectively extracts attributes from unstructured data such as item descriptions, enabling more advanced search and recommendation systems, and data analytics workflows.

In one or more embodiments, the online system 140 extracts item attributes from item descriptions. In one instance, the item descriptions are in unstructured form, such as unstructured text, such as word processing documents, e-mail messages, presentations, survey responses, transcripts, and the like. Specifically, the online system 140 prepares a prompt for input to the model serving system 150, the prompt including the item description from the item catalog and a request to perform a task to extract a set of attributes and their values for the item from the item description. The online system 140 receives a response to the prompt from the model serving system 150 based on execution of the machine-learned model using the prompt. In some embodiments, the online system 140 may access the item description from various data sources, for example, manufacturers, vendors, reviews, user feedback, and the like. The online system 140 may concatenate different descriptions from different sources and extract item attributes from the concatenated item descriptions. The online system 140 obtains the response, which includes a list of attributes and respective values associated with the item based on the item description. An “attribute” as defined herein, means one or more properties of the item, and each attribute has a respective value specific to that item. For example, “scent” is an attribute describing the scent of an item, and the value might be “lavender” for that item. In one or more embodiments, one attribute may correspond to one or more values. For example, for the “flavor” attribute of wine, the corresponding values may include “dark red fruits,” “mocha,” “vanilla,” “spices,” etc. as the wine includes various notes of flavor. The online system 140 standardizes the list of attributes, structuring the attributes and respective values into a dictionary, and standardizing the terms. For example, if an item is milk, one of the attributes may be one of “fat_content: 2%” or “fat_content: 2% fat”; the system may standardize it, so any relevant 2% milk items read as “fat_content: 2%” for consistency. The online system 140 stores the list of attributes and the respective values from the dictionary in association with the item in the item catalog. For example, the list of attributes may be used to train the search embedding model, help search retrieval and ranking by attribute matching, or create help search filters to allow users to restrict the search results to a subset of products with certain attributes.

In one or more embodiments, the online system 140 categorizes the items in terms of related and substitute items. Specifically, the online system 140 prepares a prompt for input to the model serving system 150, the prompt including the item and instructions to provide a list of items that can be purchased with the identified item. For example, the prompt may include instructions to “provide a list of additional items that could be purchased together.” The online system 140 receives a response to the prompt from the model serving system 150 based on execution of the machine-learned model using the prompt.

The online system 140 obtains the response, which includes a list of identified related items. The list of related items may be used to identify item categories. The online system 140 may store the item category that represents the list of items in association with each item on the list as well as with the original identified item. For example, the item category may be used to train the search embedding model, help search retrieval and ranking by item category matching, or create help search filters to allow users to restrict the search results to a subset of products within a certain category.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents the item catalog, a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order.

The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The item attribute module 225 extracts the item description of an item from the item catalog. In one or more embodiments, the item description is unstructured text. In another embodiment, the item description may also include other data modalities describing an item, including images, videos, audios, and the like. The item description may be unstructured in that a list of attributes and their corresponding values are not readily observable from the unstructured data. In some examples, the description may include an image of the item, a video of the item, or an audio related to the item. For example, the item description for a cleaning product may include “Kills 99.9% of bacteria (Kills 99.9% of Staphylococcus aureus and Enterobacter aerogenes). Helps eliminate odors in the air with a fresh scent. Great for vinyl, glazed ceramic, sealed marble, laminate, and finished wood floors. Do not use on unfinished, oiled, or waxed wooden boards, non-sealed tiles, or carpeted floors because they may be water sensitive.”

The item attribute module 225 generates a prompt for input to model serving system 150 by providing the item description as unstructured text or other data modalities (e.g., images, videos, audios) and requesting as output a list of attributes and respective values. In some implementations, the request in the prompt may further specify the format, content, parameters, and other components of the output. For example, the prompt may include instructions based on the provided item description,
“Create a product specification table to show on an online shopping website for the product. The second column should include the product attributes or features that could be useful for customers to understand what this product is and to compare with other similar products. In the first column, include short product attribute names corresponding to the product attributes. Output a single word “NA” if no important product attributes are mentioned in the description. Do not put attributes related to other variants for this product in the table. Fill in either “True” or “False” as the attribute value in the second column if the corresponding attribute name could be a Boolean attribute.”

The item attribute module 225 receives from model serving system 150 an output including a list of attributes and respective values associated with the item based on the description. The list of attributes and respective values may be in the form of a table with two columns or may include a set of pairs. For example, the output based on a description of cinnamon rolls may include:

“{ “flavor”: [ “cinnamon”] ,
“icing included”: [“true”],
“number of rolls”: [ “8” ],
“preparation time”: [ “13-17 minutes” ],
“suitable occasions”: [ “weekday breakfast, special holiday
treat” ]}.”

In one or more implementations, the output of the model serving system 150 is structured data, e.g., JSON data, and the item attribute module 225 may parse the JSON data and convert it into the desired data schema.

In one or more embodiments, the list of attributes may be customized by a user and/or depend on the specific items. For different categories of items, different attributes have different priorities. For example, for wine, taste feature is prioritized, for water, size or quantity is of a higher priority. For instance, a food item may have an attribute “organic” in the list, and shoes may have an attribute “closed toe” in the list. In another example, a user may modify the attributes in the list based on the user's need. In some implementations, the list of attributes may be updated, e.g., add, remove, or modify one or more attributes in the list, based on usage history, usage patterns, updates of the item, and the like. In some embodiments, for a given item, based on its corresponding category, a list of default attributes may be used for attribute extraction, and the item attribute module 225 may update the list of attributes as the item attribute module 225 receives the usage pattern and new item information.

The item attribute module 225 standardizes the attributes and values as needed. For example, if an item is milk, one of the attributes may be one of “fat_content: 2%” or “fat_content: 2% fat”; the system may standardize it, so any relevant 2% milk items read as “fat_content: 2%” for consistency. The item attribute module 225 stores the list of attributes and the respective values in association with the item in the item catalog for use by different downstream applications as extra input/features. For example, the list of attributes may be used to train the search embedding model, help search retrieval and ranking by attribute matching, or create help search filters to allow users to restrict the search results to a subset of products with certain attributes.

In one or more embodiments, the item attribute module 225 finetunes parameters of the machine learned model (e.g., LLM) deployed by the model serving system 150 with feedback on the prompt and the corresponding identified attributes. For example, the item attribute module 225 may obtain prompts that identify attributes correctly as positive feedback to finetune parameters of the machine learned model. For example, positive feedback may be obtained when a user is presented with a list of relevant items that were filtered based on extracted attributes, and for which the conversion rate was above a threshold. In one or more implementations, the item attribute module 225 may finetune the machine learned model using a plurality of training examples. Each training example may include a training prompt including at least instructions (as described above) and an item description of an item with known attributes.

During the training process, the item attribute module 225 may apply the machine learned model to the training example and receive a response from the machine learned model. The response may include a list of attributes and respective values associated with the item based on the item description of the training example in the form of one or more output tokens. In one or more embodiments, the item attribute module 225 may evaluate the response by calculating a loss. For example, the item attribute module 225 may generate a loss function and calculate a first loss indicating a difference between the known list of attributes and values output in the response and the known attributes of the item in the form of cross entropy loss between the tokens of the known attribute values and the output tokens of the estimated response.

The item attribute module 225 finetunes the machine learned model by backpropagating error terms obtained from the loss function to update parameters of the machine learned model. In this way, the item attribute module 225 finetunes the machine learned model to output a list of more accurate attributes and values. In one or more embodiments, the training examples may be updated with new information of the items. For example, the known attributes and values of an item may be updated, e.g., by adding, removing, or modifying one or more attributes in the list, based on usage history, usage patterns, updates of the item, and the like. The item attribute module 225 updates the training examples and re-trains the machine learned model with the updated training examples.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

The data store 240 stores the list of attributes and the respective values from the dictionary in association with the item in the item catalog. The stored list of attributes may be used to train one or more machine learning models. For example, the stored attributes may be used to train a search embedding model, help search retrieval and ranking by attribute matching, or create help search filters to allow users to restrict the search results to a subset of products with certain attributes.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

Workflow for Extracting Item Attributes from Item Descriptions

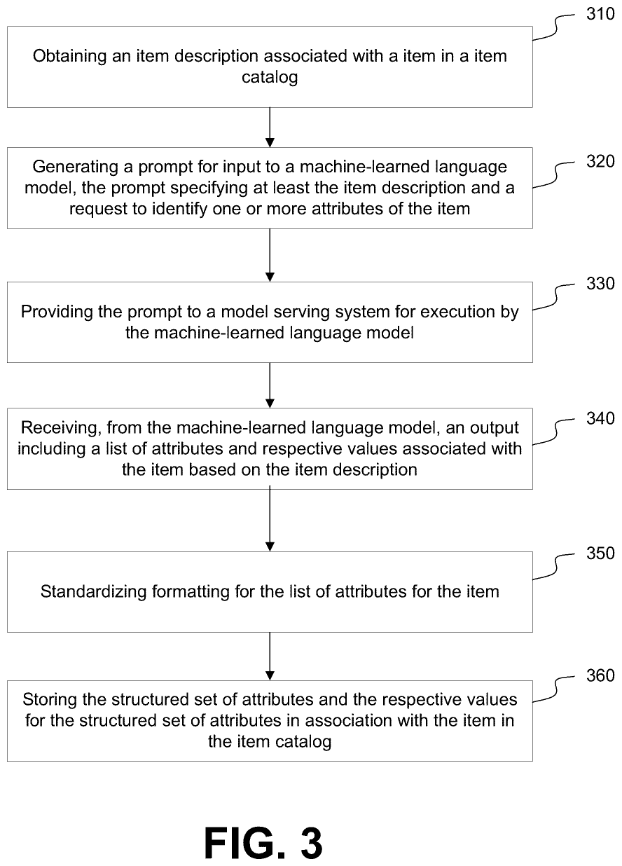

FIG. 3 is a flowchart for a method for extracting item attributes from item descriptions, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

At step 310, the online system 140 obtains an item description associated with an item in an item catalog. In one or more embodiments, the item description is unstructured text. For example, the item description for a cleaning product may include “Kills 99.9% of bacteria (Kills 99.9% of Staphylococcus aureus and Enterobacter aerogenes). Helps eliminate odors in the air with a fresh scent. Great for vinyl, glazed ceramic, sealed marble, laminate, and finished wood floors. Do not use on unfinished, oiled, or waxed wooden boards, non-sealed tiles, or carpeted floors because they may be water sensitive.”

At step 320, the online system 140 generates a prompt for input to a machine-learned language model, the prompt specifying at least the item description and a request to identify one or more attributes of the item. For example, the prompt may include instructions based on the provided item description, “create a product specification table to show on an online shopping website for the product. The second column should include the product attributes or features that could be useful for customers to understand what this product is and to compare with other similar products. In the first column, include short product attribute names corresponding to the product attributes. Output a single word “NA” if no important product attributes are mentioned in the description. Do not put attributes related to other variants for this product in the table. Fill in either “True” or “False” as the attribute value in the second column if the corresponding attribute name could be a Boolean attribute.”

At step 330, the online system 140 provides the prompt to a model serving system 150 for execution by the machine-learned language model.

At step 340, the online system 140 receives, from the machine-learned language model, an output including a list of attributes and respective values associated with the item based on the item description. The list of attributes and respective values may be in the form of a table with two columns or may include a set of pairs. For example, the output based on a description of cinnamon rolls may include “{“flavor”: [“cinnamon”], “icing included”: [“true”], “number of rolls”: [“8”], “preparation time”: [“13-17 minutes”], “suitable occasions”: [“weekday breakfast, special holiday treat”]}.”

At step 350, the online system 140 standardizes the formatting for the list of attributes for the item. For example, if an item is milk, one of the attributes may be one of “fat_content: 2%” or “fat_content: 2% fat”; the system may standardize it, so any relevant 2% milk items read as “fat_content: 2%” for consistency.

At step 360, the online system 140 stores the list of attributes and the respective values for the list of attributes in association with the item in the item catalog. For example, the list of attributes may be used to train the search embedding model, help search retrieval and ranking by attribute matching, or create help search filters to allow users to restrict the search results to a subset of products with certain attributes. In one or more embodiments, the output from the machine-learned language model includes a list of relevant items. The online system 140 may identify a relevant item category for the item and each item in the list of relevant items and stores the relevant item category in association with the item and each item in the list of relevant items in the item catalog.

In some embodiments, the online system 140 provides the item, the list of attributes and the respective values associated with the item to a user and receives, from the user, modifications to the list of attributes and the respective values associated with the item. In some implementations, the online system 140 stores the modified list of attributes and values; and in one or more implementations, the online system 140 provides to the machine-learned language model the modifications, the list of attributes, and the respective values associated with the item for further training.

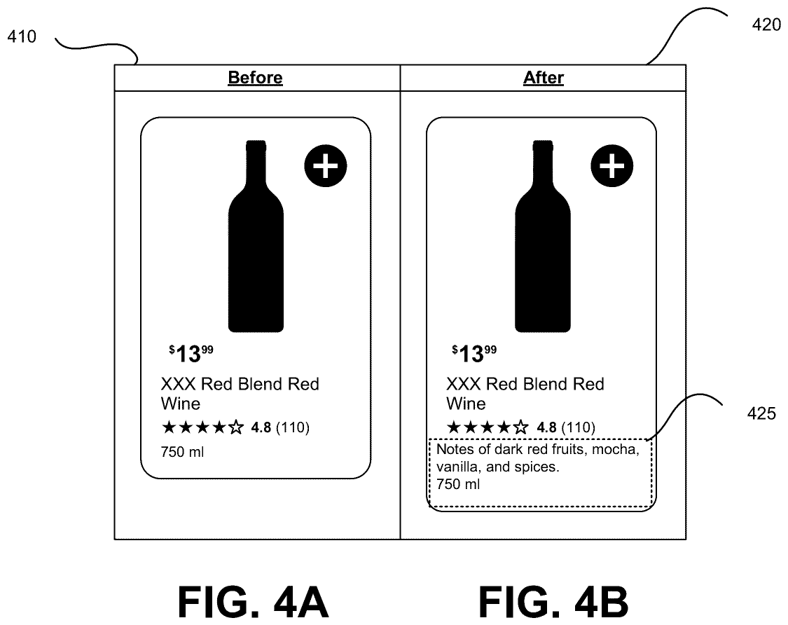

FIGS. 4A-4B are exemplary user interfaces, in accordance with one or more embodiments. Alternative embodiments may include more, fewer, or different components/configurations from those illustrated in FIGS. 4A-4B, and the functionality of each component may be divided between the components differently from the description below. Additionally, each component may perform their respective functionalities in response to a request from a human, or automatically without human intervention.

FIG. 4A illustrates an example user interface 410 before integrating a list of attributes and corresponding values, and FIG. 4B illustrates an example user interface 420 after integrating a list of attributes and corresponding values. Comparing FIG. 4A and FIG. 4B, the online system 140 causes a client device, via a user interface, to display the list of attributes for the item in an interactable user interface element 425. In some embodiments, the online system 140 may select one or more of the attributes in the list for display. For example, for the item “wine” in FIG. 4B, the interactable user interface element 425 includes an attribute “flavor” with values of “dark red fruits,” “mocha,” vanilla,” and “spices;” and an attribute “size” with a value of “750 ml.” In some embodiments, when a user interacts (e.g., clicks, tabs, hovers, etc.) with the interactable user interface element 425, the user interface may display additional information of the item, for example, other attributes in the list, to the user.

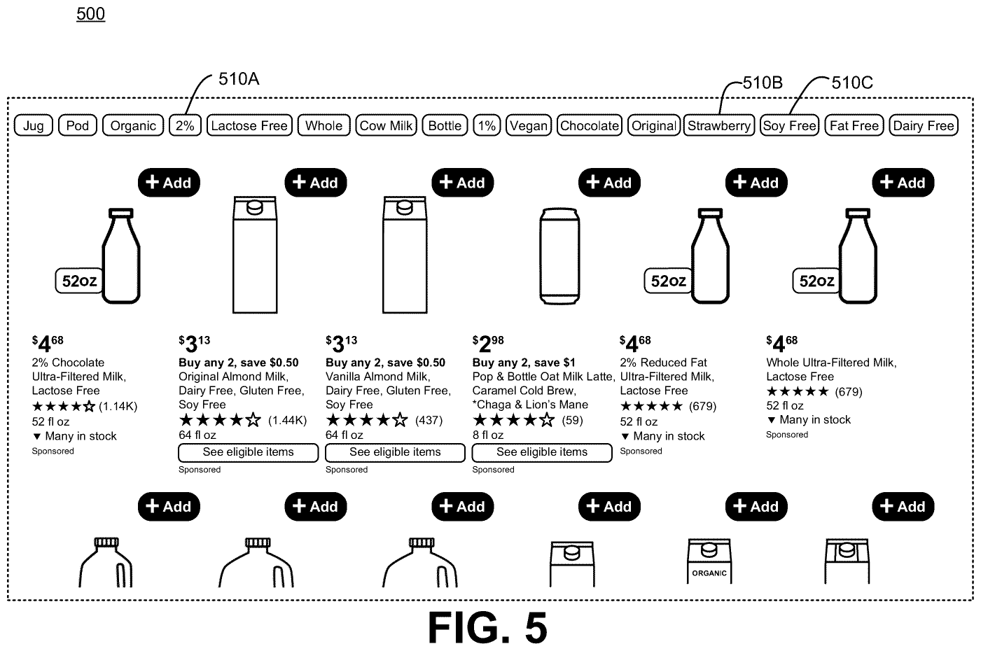

FIG. 5 illustrates another exemplary user interface, in accordance with one or more embodiments. Alternative embodiments may include more, fewer, or different components/configurations from those illustrated in FIG. 5, and the functionality of each component may be divided between the components differently from the description below. Additionally, each component may perform their respective functionalities in response to a request from a human, or automatically without human intervention.

As shown in FIG. 5, the online system 140 may cause a client device, via a user interface 500 to display one or more items to a user. The user interface 500 may include a set of interactable user interface elements, e.g., 510A, 510B, 510C, etc. Each interactable user interface element may correspond to an attribute or a value. In some implementations, the interactable user interface element may function as a filter. When a user performs an interactive action with (e.g., clicks, tabs, hovers, etc.) one user interface element, e.g., “strawberry” 510, the online system 140 may cause the user interface 500 to only display items having the attributes “strawberry.” In some embodiments, a user may interact with one or more user interface elements so that items having at least one of the one or more corresponding attributes may be displayed to the user; alternatively, only items having all of the corresponding attributes may be displayed to the user. In some implementations, the interactable user interface element may be searchable. When a user interacts with one user interface element, e.g., “Soy Free” 510C, the online system 140 may perform a search and provide a search result that includes items with the “Soy Free” attribute.

In one or more embodiments, the positions of the interactable user interface elements may be determined based on the user's historical interactive actions with the user interface elements, such as, users' click rate, interaction frequency, interaction time intervals etc. For example, more frequently interacted interactable user interface elements may be moved to a more prominent position, e.g., the first position in the row. The online system 140 may rank the interface elements based on each interface element's interaction history, such as rate, frequency, time interval, etc., and arrange the positions of the interface elements in the user interface based on each interface element's ranking position.

In one or more embodiments, the online system 140 may rank the interface element based on a user's interaction within a category of items. For example, a user's usage history indicates, when purchasing milk, a user most frequently used interface element is “Strawberry” 510B. The online system 140 may arrange the position of the user interface element “Strawberry” 510B to the first position in the row when displaying “milk” item or milk related items to the user. In another instance, the online system 140 may not only prioritize the user interface element 510B “Strawberry” for the item “milk,” but also for other items. For example, when displaying items such as wine, fragrance, etc., the online system 140 may also cause the user interface 500 to position the user interface element 510B “Strawberry” at a prominent position. In some implementations, the online system 140 may determine the rank based on overall user interactions. For example, the online system 140 determines that the interface element “organic” is the most frequently interacted interface element by a user and arranges the interface element “organic” for all food related items, at the first position in the row that displays interface elements of attributes.

In some embodiments, the online system 140 may remove a user interface element that is less frequently interacted by a user. For example, a user never interacts/clicks the user interface element “Soy Fee” 510C. The online system 140 may remove the “Soy Fee” 510C from being displayed in the user interface 500. In some embodiments, the positions of the interactable user interface elements, e.g., 510A, 510B, 510C, etc., may be determined based on user usage of a large population. In some embodiments, the position of the interactable user interface elements may be customized to meet a specific user's need/preference.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present), and B is false (or not present), A is false (or not present), and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present), and C is false (or not present). Similarly, as another not-limiting example, the condition “A, B, or C” is satisfied when A is true (or present), and B and C are false (or not present).

What is claimed is:

1. A method for extracting item attributes from item descriptions comprising:
obtaining an item description associated with an item in an item catalog;
generating a prompt for input to a machine-learned model, the prompt specifying at least the item description and a request to identify one or more attributes of the item;
providing the prompt to a model serving system for execution by the machine-learned model;
receiving, from the machine-learned model, an output including a list of attributes and respective values associated with the item based on the item description; and
storing the list of attributes and the respective values for the list of attributes in association with the item in the item catalog.

2. The method of claim 1, further comprising:
providing the item, the list of attributes and the respective values associated with the item to a user device;
receiving modifications to the list of attributes and the respective values associated with the item; and
providing, to the machine-learned model, the modifications, the list of attributes, and the respective values associated with the item for further training of parameters of the machine-learned model.

3. The method of claim 1, wherein the output from the machine-learned model includes a list of relevant items, the method further comprising:
identifying a relevant item category for the item and each item in the list of relevant items; and
storing the relevant item category in association with the item and each item in the list of relevant items in the item catalog.

4. The method of claim 1, further comprising finetuning parameters of the machine-learned model to generate an updated machine-learned language model, the finetuning comprising:
applying the machine-learned language model to a training prompt of a training example, the training example comprising another item description of another item with a set of known attributes;
receiving, from the machine-learned model, an estimated response;
generating a loss function indicating a difference between the estimated response and the set of known attributes; and
backpropagating terms obtained from the loss function to update the parameters of the machine-learned model.

5. The method of claim 1, further comprising:
providing one or more of the list of attributes for the item for display on a user interface, wherein each attribute is displayed in an interactable user interface element in the user interface.

6. The method of claim 1, further comprising:
providing a set of attributes associated with a set of items for display on a user interface, wherein each attribute is displayed in an interactable user interface element in the user interface;
receiving an interactive action with at least one user interface element; and
modifying the user interface to display one or more of the set of items that are associated with an attribute displayed by the at least one user interface element.

7. The method of claim 6, further comprising modifying positions of the user interface elements displayed in the user interface based on historical user interactive actions associated with the attributes displayed in the user interface elements.

8. A computer program product comprising a non-transitory computer readable storage medium having instructions encoded thereon that, when executed by a processor, cause the processor to perform steps comprising:
obtaining an item description associated with an item in an item catalog;
generating a prompt for input to a machine-learned model, the prompt specifying at least the item description and a request to identify one or more attributes of the item;
providing the prompt to a model serving system for execution by the machine-learned model;
receiving, from the machine-learned model, an output including a list of attributes and respective values associated with the item based on the item description; and
storing the list of attributes and the respective values for the list of attributes in association with the item in the item catalog.

9. The computer program product of claim 8, wherein the instructions encoded thereon that, when executed by a processor, cause the processor to perform steps comprising:
providing the item, the list of attributes and the respective values associated with the item to a user device;
receiving modifications to the list of attributes and the respective values associated with the item; and
providing, to the machine-learned model, the modifications, the list of attributes, and the respective values associated with the item for further training of parameters of the machine-learned model.

10. The computer program product of claim 8, wherein the output from the machine-learned model includes a list of relevant items, the instructions encoded thereon that, when executed by a processor, cause the processor to perform steps comprising:
identifying a relevant item category for the item and each item in the list of relevant items; and
storing the relevant item category in association with the item and each item in the list of relevant items in the item catalog.

11. The computer program product of claim 8, wherein the instructions encoded thereon that, when executed by a processor, cause the processor to perform steps comprising: comprising finetuning parameters of the machine-learned model to generate an updated machine-learned language model, the finetuning comprising:
applying the machine-learned language model to a training prompt of a training example, the training example comprising another item description of another item with a set of known attributes;
receiving, from the machine-learned model, an estimated response;
generating a loss function indicating a difference between the estimated response and the set of known attributes; and
backpropagating terms obtained from the loss function to update the parameters of the machine-learned model.

12. The computer program product of claim 8, wherein the instructions encoded thereon that, when executed by a processor, cause the processor to perform steps comprising:
providing one or more of the list of attributes for the item for display on a user interface, wherein each attribute is displayed in an interactable user interface element in the user interface.

13. The computer program product of claim 8, wherein the instructions encoded thereon that, when executed by a processor, cause the processor to perform steps comprising:
providing a set of attributes associated with a set of items for display on a user interface, wherein each attribute is displayed in an interactable user interface element in the user interface;
receiving an interactive action with at least one user interface element; and
modifying the user interface to display one or more of the set of items that are associated with an attribute displayed by the at least one user interface element.

14. The computer program product of claim 13, wherein the instructions encoded thereon that, when executed by a processor, cause the processor to perform steps comprising: modifying positions of the user interface elements displayed in the user interface based on historical user interactive actions associated with the attributes displayed in the user interface elements.

15. A computer system comprising:
a processor; and
a non-transitory computer-readable storage medium having instructions that, when executed by the processor, cause the computer system to perform steps comprising:
obtaining an item description associated with an item in an item catalog;
generating a prompt for input to a machine-learned model, the prompt specifying at least the item description and a request to identify one or more attributes of the item;
providing the prompt to a model serving system for execution by the machine-learned model;
receiving, from the machine-learned model, an output including a list of attributes and respective values associated with the item based on the item description; and
storing the list of attributes and the respective values for the list of attributes in association with the item in the item catalog.

16. The computer system of claim 15, wherein the instructions, when executed by the processor, cause the computer system to perform steps comprising:
providing the item, the list of attributes and the respective values associated with the item to a user device;
receiving modifications to the list of attributes and the respective values associated with the item; and
providing, to the machine-learned model, the modifications, the list of attributes, and the respective values associated with the item for further training of parameters of the machine-learned model.

17. The computer system of claim 15, wherein the output from the machine-learned model includes a list of relevant items, the instructions, when executed by a processor, cause the computer system to perform steps comprising:
identifying a relevant item category for the item and each item in the list of relevant items; and
storing the relevant item category in association with the item and each item in the list of relevant items in the item catalog.

18. The computer system of claim 15, wherein the instructions, when executed by the processor, cause the computer system to perform steps comprising:
finetuning parameters of the machine-learned model to generate an updated machine-learned language model, the finetuning comprising:
applying the machine-learned language model to a training prompt of a training example, the training example comprising another item description of another item with a set of known attributes;
receiving, from the machine-learned model, an estimated response;
generating a loss function indicating a difference between the estimated response and the set of known attributes; and
backpropagating terms obtained from the loss function to update the parameters of the machine-learned model.

19. The computer system of claim 15, wherein the instructions, when executed by the processor, cause the computer system to perform steps comprising:
providing one or more of the list of attributes for the item for display on a user interface, wherein each attribute is displayed in an interactable user interface element in the user interface.

20. The computer system of claim 15, wherein the instructions, when executed by the processor, cause the computer system to perform steps comprising:
providing a set of attributes associated with a set of items for display on a user interface, wherein each attribute is displayed in an interactable user interface element in the user interface;
receiving an interactive action with at least one user interface element; and
modifying the user interface to display one or more of the set of items that are associated with an attribute displayed by the at least one user interface element.
